(19) United States
(12) Patent Application Publication
(10) Pub. No.: US 2022/0363004 A1
(43) Pub. Date: Nov. 17, 2022

(54) GENERATION OF MODIFIED MODEL DATA FOR THREE-DIMENSIONAL PRINTERS

(71) Applicant: Hewlett-Packard Development Company, L.P., Spring, TX (US)

(72) Inventor: Patrick Daney de Marcillac, Grenoble (FR)

(73) Assignee: Hewlett-Packard Development Company, L.P., Spring, TX (US)

(21) Appl. No.: 17/761,345

(22) PCT Filed: Oct. 16, 2019
(86) PCT No.: PCT/US2019/056441

§ 371 Date: Mar. 17, 2022

(51) Int. Cl. B29C 64/386; B33Y 50/00; G05B 19/4099

(52) U.S. Cl. CPC B29C 64/386; B33Y 50/00; G05B 19/4099; G05B 2219/35134; G05B 2219/49023

(57) ABSTRACT

Model data is obtained, defining parts to be generated by a three-dimensional printer. A sprue is determined to connect the parts, and a label is automatically generated on the sprue which identifies the parts connected to the sprue. Modified model data is generated representing the parts and the sprue.

### BACKGROUND

Following a build operation to generate printed parts in a three-dimensional (3D) printer, the printed parts may be subjected to post-processing operations, for example de-caking or dyeing. Depending on the specification for each part, different printed parts may be subject to the same or different post-processing operations.

### BRIEF DESCRIPTION OF THE DRAWINGS

FIG. 1 shows schematically an example object that may be printed, made up of a number of parts connected by a sprue.

FIG. 2 shows an example of a part and a sprue connected via a directionally weak hybrid connection.

FIG. 3 shows an example of a part connected to a sprue via dual hybrid connections designed for directional separation.

FIG. 4A shows an example of a cross-sectional view of a directionality weak hybrid connection designed for counter clockwise weakness.

FIG. 4B illustrates a side profile of the directionally weak hybrid connection of FIG. 4A.

FIG. 5A shows another example of a cross-sectional view of a directionality weak hybrid connection designed for counter clockwise weakness.

FIG. 5B illustrates a side profile of the directionally weak hybrid connection of FIG. 5A.

FIG. 6A shows another example of a cross-sectional view of a directionality weak hybrid connection designed for counter clockwise weakness.

FIG. 6B illustrates a side profile of the directionally weak hybrid connection of FIG. 6A.

FIG. 7 shows an example procedure for printing an object made up of parts connected by a sprue.

FIG. 8 is a flowchart showing an example method for generating modified model data.

FIG. 9 is a flowchart showing a further example of a method for generating modified model data.

FIG. 10 shows an example controller configured to generate modified model data.

FIG. 11 shows an example of a computer readable medium comprising instructions to generate modified model data.

### DETAILED DESCRIPTION

After completion of the build operation in a 3D printer or other additive manufacturing system, printed parts may be subject to downstream workflows such as post-processing operations. These workflows may differ between parts being printed, particularly in the case where multiple designs from different designers are being printed in a single build job by a print service provider. For example, these workflows may include de-caking, cleaning and/or dyeing. In some instances, different parts may need to be separated for different downstream workflows after printing. Such separation of respective parts may be conducted by an operator or by an automated system. Such an operator or system may identify which of the printed parts need to be allocated to which downstream workflow, in order for the parts to undergo the appropriate post-processing operations.

The present disclosure describes how a sprue may be determined that is suitable for connecting parts together so that they may be handled as a single object in a downstream workflow. The parts may be handled together up to a point where the object may be divided into smaller sub-groups for sub-workflow differentiation. After this, the parts may be detached individually from the sprue. Grouping the parts in this way may give rise to workflow efficiency gains, wherein parts being subjected to a given post-processing operation may be handled as a single object instead of being processed individually.

The present disclosure describes how, during a pre-print procedure, model data defining parts to be printed may be used to determine the sprue and generate modified model data representing both the parts and the sprue.

In an example, the process of producing 3D-printed parts that undergo specific workflows may include: (i) part and build preparation; (ii) 3D printing; and (iii) post-processing workflows. During the part and build preparation, a digital model of each of the parts to be printed, comprising model data representing the parts, may be generated or received by a pre-print application.

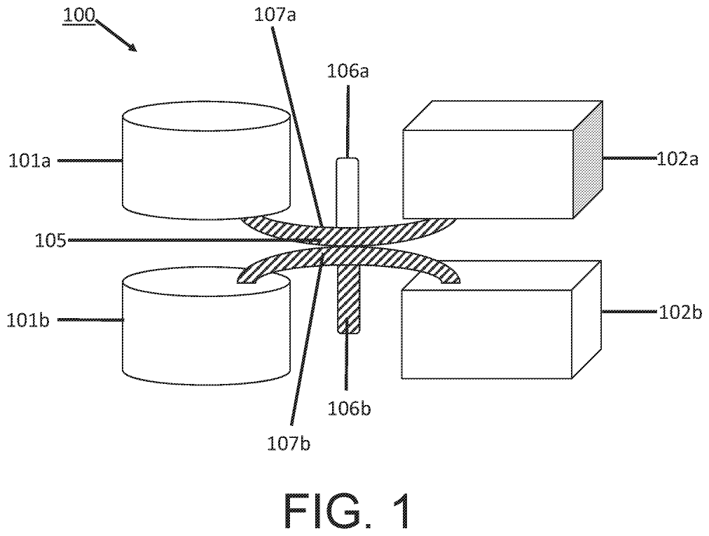

FIG. 1 shows schematically an example of an object 100 that may be determined, being made up of a sprue 105 to connect parts 101a, 101b and 102a, 102b when the parts are printed, and during subsequent post-processing. In this example, the sprue comprises handle portions 106a, 106b and sprue sections 107a, 107b connecting the individual parts. The handle portions may facilitate handling of the object by an operator or handling system after printing, for example during post-processing. In this example, two sets of two parts are depicted, each set of parts being provided with a respective handle portion and sprue section.

Suitable contact locations for the sprue, defining positions on the parts where one or a plurality of sprues may be connected, may either be included in the model data by the designer or identified afterwards. If not included in the model data, the contact locations may be determined either automatically and/or with user input. For example, the contact locations may be determined automatically based on a determination of aesthetically less significant regions of the parts. In some examples, an automatically determined contact location may be updated or adjusted by a user. In other examples, the contact locations may be determined entirely manually by a user. The sprue may be designed so as to be frangible connected to the part at the contact location, to facilitate subsequent detachment.

Parameters specifying the size and location of the sprue 105 may be determined manually by a user, or automatically in the pre-print application. A plurality of sprues may be provided in some examples, to facilitate handling of one or more parts. In some examples, parameters may be specified by a combination of manual and automatic processes, for example by the pre-print application generating a proposed sprue which may then be accepted, rejected or modified by the user. This determination may take into account degrees of freedom within limits permitted by a specified sprue type. For example, a particular type of sprue may have a specified minimum radius of curvature to avoid weak points. Determined parameters of the sprue, and/or the sprue type, may include parameters regarding the type of connection between the sprue and the part. The sprue may be determined by selecting a sprue construction from a set of predetermined sprue constructions, based on the model data. The sprue may also be determined in such a way as to connect to the specified contact locations whilst minimizing the sprue length, in order to reduce material costs associated with the sprue and maximise strength. This may be achieved by selecting contact locations on respective parts that are closest together and/or by moving parts within the model, to reduce the distance between parts. Part packing rules may be applied here to increase the part packing density whilst maintaining part quality during printing. For example, these part packing rules may place a limit on how close individual parts 101a, 101b and 102a, 102b may be positioned in proximity to one another. This particular rule may, for example, be specified by the designer of the parts, or otherwise included in the model data.

In this example, the sprue includes an automatically generated label which identifies the parts connected to the sprue. The label may be located on the handle portion 106a, 106b, and each of the handle portions 106a, 106b may include a respective label. The label(s) may enable the attached parts to be identified after the printing stage. In some examples, these labels may be used for quality assurance of the printing process by comparing the printed parts to the original modified model data input to the printing stage. In some examples these labels may be used to separate the printed parts for different downstream workflows depending on the part identification. Such a label may be used to add a unique identification to a part during post-processing, and may enable the part identification to be linked to the placement of the part in the model data. This enables increased traceability control when several parts of the same type are printed in the same model, since the position of each part may be linked to a unique part identification and then to the sprue label.

The sprue may be of various types, each type having a respective structure and type of fill. For example, some sprues might be solid while others may have honeycomb or other non-solid interior structures to save material cost and weight. The sprue has a density and material cost per unit length, and may be specified by parameters depending on the type of sprue. Such parameters may include details of the cross-section, e.g. diameter for a circular section or orthogonal dimensions for a rectangular section, and may also include a radius of curvature. Sprue parameters may also include specified orientations, for example horizontal sprues may be specified in a particular instance instead of vertical sprues, depending on the design and properties of the parts to be printed.

In some examples, an angular radius of the sprue may have an associated minimum so as to ensure strength of the sprue when printed. In some examples, the angular radius may be determined in accordance with a part to be printed, wherein smaller parts may be allocated smaller sprues because a strength needed to support them is reduced. Part packing rules for the parts may also include the avoidance of aesthetically significant regions of the parts. For example, smaller parts will be more aesthetically impacted by a larger sprue contact area than would a larger part. In some examples, the angular radius may be determined in accordance with maintaining this strength whilst reducing the overall cost of the design. In some examples, the dimensions of the sprues may also be determined taking into the account the downstream workflows. For example, large dimension sprues may negatively affect the effectiveness of certain post-processing operations on printed parts, such as cleaning, decaking and dyeing.

In some examples, multiple contact locations may be identified, which may each be allocated a respective sprue. This may be beneficial where a single smaller sprue, selected to reduce aesthetic impact, would be too small to ensure sprue strength. Multiple sprues may then enable a stronger overall connection at different positions of low aesthetic importance on the part.

In some examples each part may be connected to a respective section of a sprue, and the sprue sections may have differing properties. For example, the dimensions of the sprue sections may vary depending on the size of the part. In some examples, parts may each be provided with multiple sprue sections of different, or the same, properties.

The handle portion(s) may be designed to fit into stand fixtures in downstream workflow processes or post-processing operations, and/or may include features for facilitating an operator, or an automated handling system or robot, to identify or manipulate the sprue and the connected parts. The handle portions may be determined automatically, such that the downstream workflow processes are recognised for a particular part or parts and used to specify the handle portions accordingly.

It should be understood that FIG. 1 represents a particular example of the object, comprising the sprue and the attached parts. In other examples, the model data may represent any number of the same, or different, parts to be printed by a 3D printer.

The connection between the sprue and the part may take any appropriate form that is sufficiently strong to allow the part to remain attached to the sprue during handling and post-processing following printing, but which enables the part to be detached from the sprue by an operator, automated handling system, or end user, at an appropriate time. The connection may be one of any number of predetermined types for attaching the sprue to the connection location, or socket, provided in the part.

In one example, the connection type is a hybrid connection designed to provide sufficient strength to maintain the connection during handling, but to facilitate detachment when a force is applied in a particular direction. These hybrid connections may include an alternating pattern (a “hybrid pattern”) of fully-fused and under-fused materials of a printing substance. In one example, the hybrid pattern may be such that an outside rim of the connection is fully fused and an inside portion of the connection is under-fused. In another example, the hybrid pattern may fully fuse the corners of the connection and under fuse the remaining portion of the connection. Accordingly, the hybrid pattern may comprise any of a wide variety of patterns of fully-fused and under-fused locations. For example, the hybrid pattern may comprise any cross-sectional pattern of fully-fused and under-fused connections between the part and the sprue. The terms “fully-fused” and “under-fused” may describe degrees of fusion of a build material in a variety of 3D printing technologies, for example, 3D binder jetting, thermal fusion printing, selective laser sintering, and other powder-based 3D printing systems. In 3D binder jet printing, “fully-fused” and/or “under-fused” may refer to the liquid binder agent disposed to join the powder particles. In selective laser sintering, “fully-fused” and/or “under-fused” may refer to the laser fusing of the powder.

In powder-based 3D printing systems, under-fused sections may be realized by, for example, utilizing a lower-than-normal fusing temperature, shortening the fusing time, and/or the like. A shortened fusing time may produce under-fused sections by generating a porous microstructure, which results in reduced mechanical strength. A variation in temperature may strengthen or weaken the under-fused sections. For example, a lower fusing temperature may generate a weaker under-fused section whereas a higher fusing temperature may generate a stronger under-fused section. In thermal fusion printing, under-fused sections may, for example, be realized by utilizing fewer fusing agents and/or adding more detailing agents. Fusing agents are applied to a material layer to fuse the particles together. Detailing agent is applied to modify fusing and create fine detail and smooth surfaces, and may be weaker than fusing agents. The strength of the under-fused section may be selectively modified by varying the relative quantities of fusing agent and detailing agent. For example, an under-fused section with more fusing agent than detailing agent may be stronger than an under-fused section with more detailing agent than fusing agent.

In some examples, the type of connection between a sprue and a part, which may comprise an arrangement of fused and under-fused layers, may be selected from a set of predetermined connection types. In some examples, the connection type may be newly determined based on the received model data. The determination of the connection type may, in some examples, take into account part packing rules provided by the designer. For example, the packing of the parts may aim to minimize potential scars that may be left on the parts once detached from the sprue. In some examples this may be relevant where parts are detached later in the post-processing workflow or, for example, when they are detached by the end user, since in these examples there are fewer post-processing operations after the detachment, which might otherwise be used to reduce the extent of the scar. Such a set of predetermined connection types may also be used, in some examples, to determine the type of connection between two or more sections of a single sprue, such that the parts attached to a sprue may be detached into sub-groups by separating the sprue into individual sprue sections.

The set of predetermined connection types may include a cross-sectional pattern of fully-fused and under-fused connections, wherein the cross-sectional pattern may comprise, for example:
a matrix of alternating rectangles of fully-fused connections and under-fused connections;
a pattern of alternating polygons of fully-fused connections and under-fused connections; or
an under-fused connection having a first cross-sectional area, and either a fully-fused connection or a plurality of fully-fused connections within the first cross-sectional area.

The above list of connection types serves as an example list, whilst other varieties of different arrangements are also possible. The predetermined connection types may also incorporate other connection types comprising separated regions of fully-fused and under-fused material.

In some examples, determination of the sprue may be carried out automatically, and may utilise machine learning techniques such that properties of a sprue may be applied to equivalent print jobs without having to continually determine the sprue for every print job. In some examples, machine learning may be utilized to quickly suggest sprues for closely related print jobs.

Digital models of parts to be printed, and the determined sprue(s), may be packed into the available build volume, either manually or using an automated packing scheme. A sprue may include a respective label that may be used to identify the attached parts after printing. A record may be stored, for example in a database, of manufacturing information for each part connected to the sprue, and the label may be associated with this record. The manufacturing information may include the position and orientation of the parts in the print bed of a 3D printer, once the models of the parts are packed into the build volume.

Modified model data may then be generated representing both the parts to be printed and the sprue. The pre-print application may generate slices of the modified model data which may be sent to the printer for printing. Alternatively, the slices of the modified model may be extracted within the printer itself to generate the print data. During 3D printing, the parts and sprue may be generated by the 3D printer.

After printing, in some examples of the post-processing procedure, a printed object may be scanned in order to generate a digital fingerprint of each respective part, which may be used to link each part to the label on the sprue to which the parts are attached. This digital fingerprint may be stored in the database record for the part. In some examples, this digital fingerprint may be associated with a manufacturing history of the part, providing an incremental history of the manufacturing processes the part has gone through. For example, this digital history may point to the original modified model data and may identify information such as the identity of the printer on which the part was manufactured, the time of manufacture, and the location of the part within the build volume, which may give information about the temperature profile of the printed layers in the bed region where the part was printed. Each record may be supplemented with the actual scan of the part may include information regarding its geometric, dimensioning and tolerance (GD&T) vetting. Other workflow data related to the part's printing history may also be incorporated into this record. Each part and its manufacturing history may then be uniquely recognized, via its respective fingerprint. Scanning of the printed parts, and relating the printed parts to their respective record, may allow quality assurance of the printed parts. This scanning phase may be performed at any time in the post-print stages, such that the parts may be scanned at any time from immediately after printing to the final stage before packing the printed parts, for example.

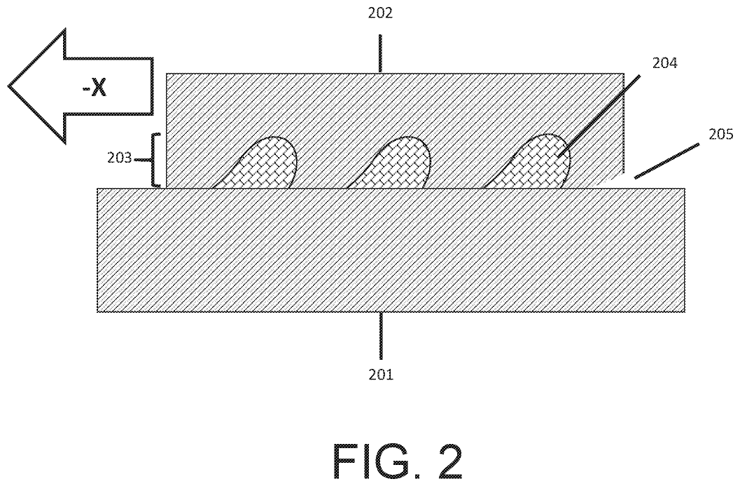

FIG. 2 illustrates an example of a part 201 and a sprue 202 connected via a directionally weak hybrid connection 203 comprising multiple under-fused connections 204 within a surrounding fully-fused material. The angular profile of the under-fused connections 204 in one direction facilitates propagation of tearing the connection in a direction from right to left, illustrated as direction −X by the arrow in FIG. 2, to remove the part 201 from the sprue 202.

The rounded end of the under-fused connections provides increased resistance to tearing in other directions. The 3D print design may include a wedge shaped cavity 205 to seed a start for right-to-left tearing of the connection to separate the part from 201 from the sprue 202. The reduced contact area of fully-fused material of the connection between the sprue 202 and the part 201 reduces scarring and/or residual material on the part after detachment. The hybrid connection may be formed as part of the end of the sprue (e.g. have the same cross-sectional dimensions as the sprue 202) or be a separate section with different dimensions than either the sprue 202 or the part 201.

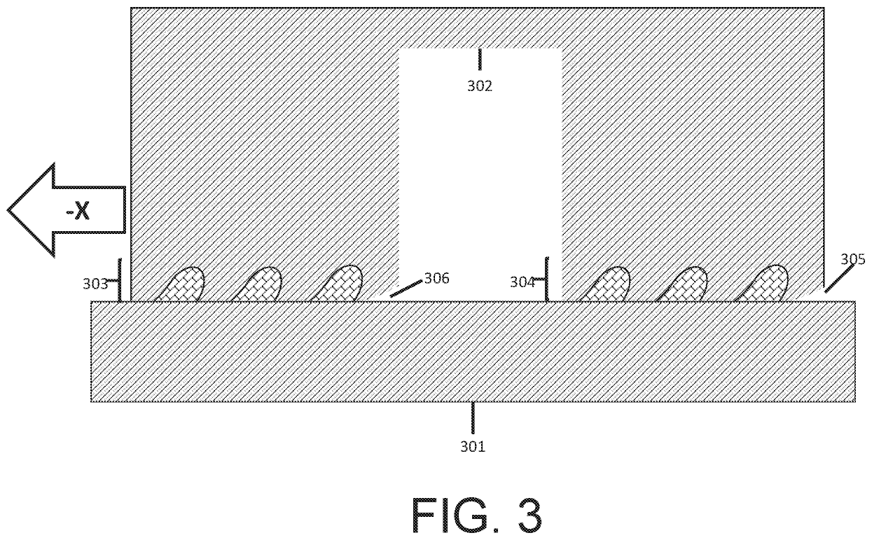

FIG. 3 illustrates an example of a part 301 connected to a sprue 302 via dual hybrid connections 303 and 304 that each include multiple under-fused connections within the fully-fused material. Each of the dual hybrid connections 303 and 304 is configured to be directionally weak with a tear start wedge 305 and 306 to allow for tearing of the connection from right to left (i.e. in the −X direction illustrated by the arrow in FIG. 3). The illustrated dual connection minimizes the effect of any leveraged moment effect due to forces applied further away from the connection. Specifically, regardless of whether the force is applied near the dual hybrid connections 303 and 304 or near the top of the sprue 302, a similar or identical force is required to separate the part 301 from the sprue 302.

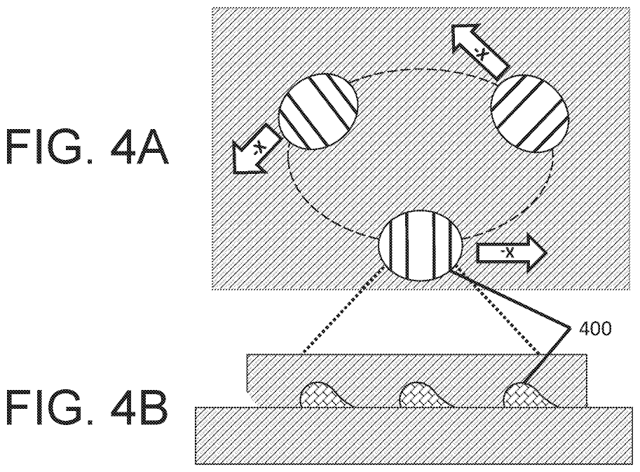

FIG. 4A illustrates an example of a cross-sectional view of a directionally weak hybrid connection designed for counterclockwise weakness. In the illustrated connection, each of the three under-fused connections 400 within the fully-fused material of the connection is oriented to be directionally weak in the −X direction. Accordingly, counterclockwise rotation of the connection requires less force to tear the connection than would be required via lateral force or clockwise rotation.

FIG. 4B illustrates a side profile of one portion (defined by the connecting dashed lines) of the directionally weak hybrid connection of FIG. 4A showing the under-fused connections 400. Comparing FIGS. 4A and 4B, it can be seen that the example under-fused connections 400 comprise an elongated section of under-fused material arranged in rows with opposing angled portions and rounded portions oriented in the −X direction.

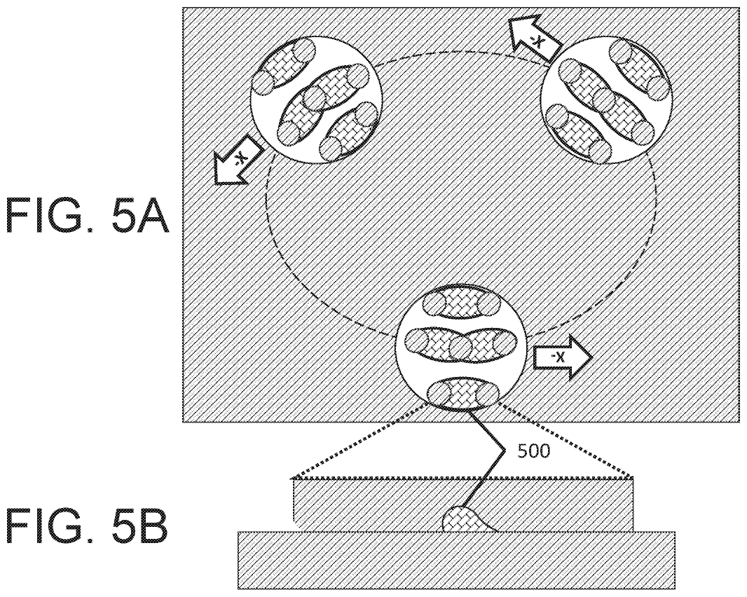

FIG. 5A illustrates another example of a cross-sectional view of a directionally weak hybrid connection designed for counterclockwise weakness.

FIG. 5B illustrates a side profile of one portion (defined by the connecting dashed lines) of the directionally weak hybrid connection of FIG. 5A. Comparing FIGS. 5A and 5B, it can be seen that each hybrid connection 500 includes portions of under-fused material and fully-fused material with angled portions and rounded portions oriented in the −X direction.

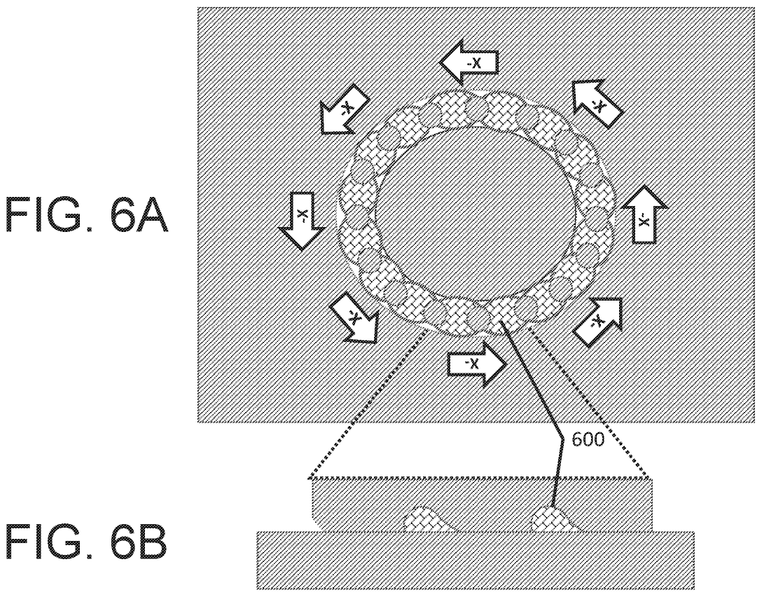

FIG. 6A illustrates another example of a cross-sectional view of a directionally weak hybrid connection designed for counterclockwise weakness.

FIG. 6B illustrates a side profile of one portion (defined by the connecting dashed lines) of the directionally weak hybrid connection of FIG. 6A. Comparing FIGS. 6A and 6B, it can be seen that the hybrid connection 600 comprises alternating portions of under-fused material and fully-fused material, where the under-fused material includes angled portions and rounded portions oriented in the counterclockwise −X direction.

It should be understood that FIGS. 2 to 6 represent examples of types of connections that may be used to connect a sprue to a part, or to connect different sections of a sprue to one another, and which may be included in a set of predetermined connection types from which a type is selected. Any type of connection may be included in the set, and an appropriate type may be selected depending on the constraints of the build job. It is also possible to incorporate different types of connection in a single build job, such that different parts in the build volume are connected to a respective sprue by different respective connection types.

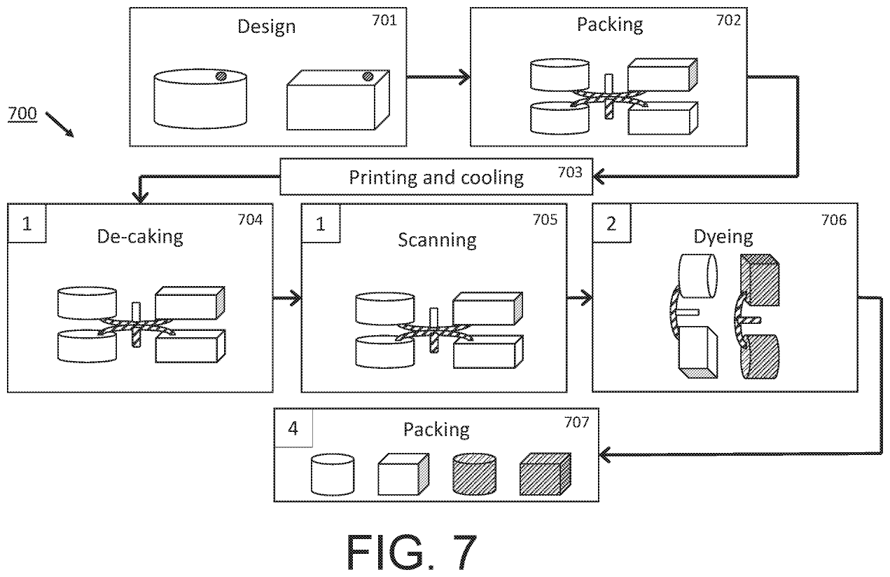

FIG. 7 shows an example process 700 for preparing and printing parts, including post-print workflows which may be applied to the parts. In this example, two sets of two different types of part are specified to be printed. Boxes in the top left corner of the stages identify the number of operations taken to complete the procedure.

In the procedure of FIG. 7, a design representing the parts to be printed is received 701 in the form of model data. In this example, the specified parts to be printed are two copies of each of two different parts, i.e. four parts in total, with the two parts of each type dyed in different colours. These parts may originate from a single designer, or from multiple designers, and the parts are to be printed in a single build job. The model data may include suitable contact locations for one or more sprues, or such contact locations may be determined after receiving the data. Packing is then performed at 702, and the sprue is determined, including a label identifying the parts attached to the sprue. In this example, the sprue includes two handle portions, and the sprue is connected to the respective locations on the parts as identified in the model data. The parts and the sprue are then printed and allowed to cool 703. The parts are then de-caked 704, which may be performed in one operation for all of the parts since the sprue connects all four parts and allows them to be handled as a single object. The parts are scanned 705. This scanning stage may look for errors in the printing procedure relative to the received model data. The scanning procedure may also generate a digital fingerprint of each part and associate this digital fingerprint with a record for each part. With this identification, the parts may be detached into the sets of parts, and may be dyed 806 for the desired workflows. At 706, the parts are dyed according to the design. In this case, two sub-groups of two parts each are to be dyed two different colours. It can be seen that in this example the sprue is determined such that it comprises two sections, each section being connected to two of the four parts. The two sections are frangibly connected to one another to enable separation of the parts connected to each sprue section into the two sub-groups. One sub-group of two parts is then dyed a first colour, and the second sub-group is dyed a second colour. By separating the sprue into two sections in this way, the two sub-groups of parts are able to be subjected to different workflows, but each sub-group is still able to be handled as a single object. In the final packing stage 707, the individual parts are detached from the respective sprue sections and packed.

It will be appreciated that the use of a sprue enables all four parts to be handled as a single object during, for example, the de-caking and scanning processes, rather than requiring four individual parts to be handled and processed at each stage, thereby reducing the number of processing operations. As can be seen in FIG. 7, de-caking and scanning therefore takes a single processing operation. However, at the point where the workflows diverge for different sub-groups of the parts, which in this example occurs at the dyeing stage, the use of a sprue which is divisible into two sections enables the four parts to be handled and processed as two objects, which are subjected to two different respective dyeing processes, rather than being handled as four separate objects. As can be seen in FIG. 7, the dyeing stage takes two operations for the four parts. Therefore, even where the workflows diverge for different parts, it is still possible to reduce the number of processing operations compared with handling the parts individually. It should be noted that, depending on the number of parts and the respective workflows, at least one of the sprue sections may be further frangibly divisible to enable separation of parts connected to the at least one sprue section into further sub-groups of at least one part.

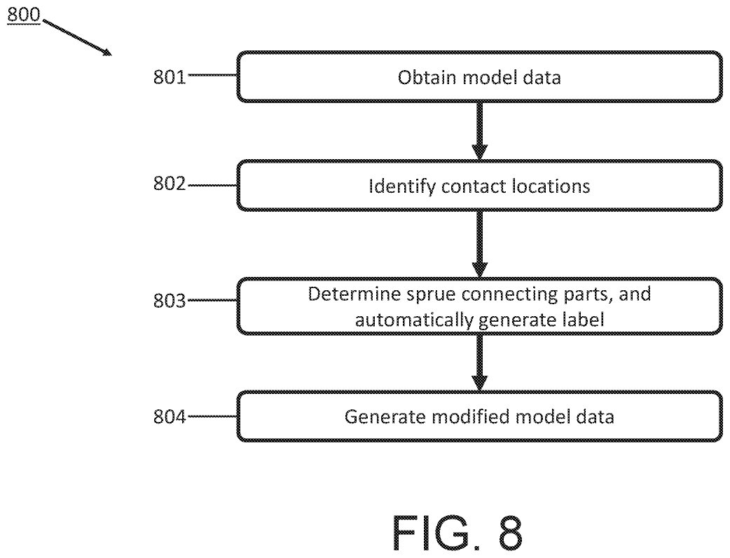

FIG. 8 shows an example of a method 800 for generating printer control data comprising build data to control a 3D printer to generate parts and a sprue. The method comprises obtaining 801 model data defining parts to be generated by a 3D printer, identifying 802 contact locations on each of the parts; and determining 803 a sprue suitable to connect to the parts at the contact locations. Determining the sprue includes automatically generating on the sprue a label identifying the parts connected to the sprue. The label may be used to identify the respective parts, and the specified post-print workflows for each part, after printing. In some examples, the sprue comprises one or more handle portions to facilitate handling of the printed object by an operator or handling system after printing. At 804, modified model data is generated, representing both the parts and the sprue. This modified model data may be used to generate slices in a pre-print application which may then be transmitted to a 3D printer, or such slices may be generated within the printer itself.

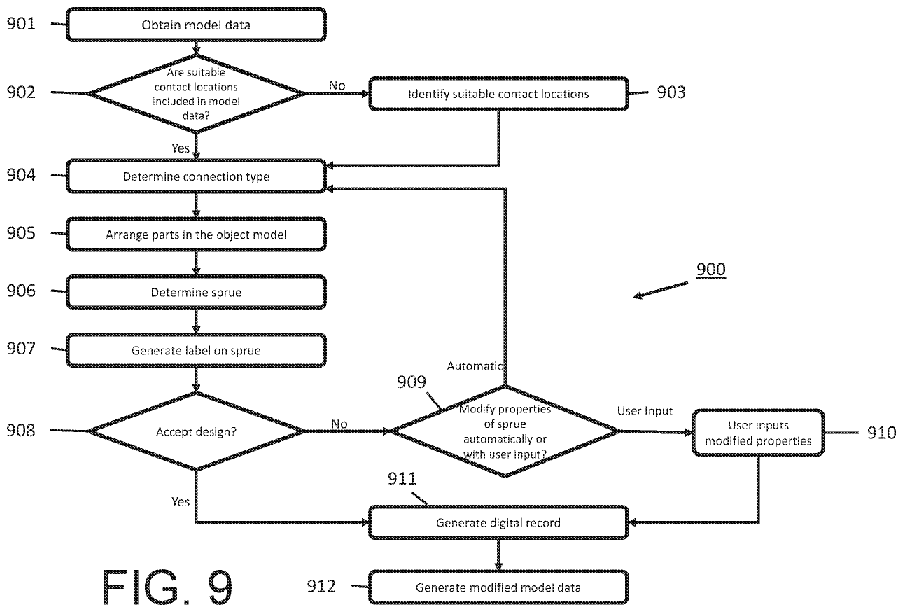

FIG. 9 shows an example of a method 900 for generating printer control data comprising build data to control a 3D printer to generate a plurality of parts connected by a sprue. The method comprises obtaining 901 model data defining parts to be generated by a 3D printer. At 902, it is determined whether the model data includes suitable contact locations on the individual parts where the sprue may be connected. If they are not specified, these contact locations are determined 903, either automatically, manually, or a combination of both.

At 904, the connection type is determined. As described above, the connection type may be determined based on any appropriate criteria, which may be constrained by specified part packing rules.

The parts are arranged 905, or packed, in the object model, based on any specified part packing rules. For example, the parts may be arranged so as to reduce the distance between identified sprue contact locations, in order to reduce the length, and hence additional material cost, of the sprues. This arrangement may include rotating or otherwise repositioning the parts within the build volume. In some examples, this arrangement may include slightly extending the packing gaps between the parts in order to leave room for the sprue. Based on this arrangement, a sprue is determined at 906. In accordance with the discussion above, this sprue may include handle portions, and may comprise a plurality of frangible connected sections.

A label is generated on the sprue at 907. The label provides unique identification of the parts connected to the sprue. In some examples this identification may be used for linking the printed parts to a digital history of the parts, and/or to identify groups of parts requiring different downstream workflow procedures. The label may be of any suitable type, or of a particular type applicable to a respective downstream workflow process. For example, a 3D data matrix, ultraviolet (UV) reacting light markings, thermal bleed marks, or engraved or embossed marks may be used as labels. It should be understood that print jobs with multiple sets of parts may incorporate different types of labels on different sprues and/or on different sprue handle portions.

At 908 it is determined whether the design of the parts and sprue is approved by a use or automated process. If not approved, the design may be modified at 909, either automatically or with user input at 910. If the properties are updated automatically, the process may repeat 904 to 908. In some examples, the user may isolate a particular feature of the sprue to update. In some examples the user may also provide a general instruction that may be taken into account when automatically determining the sprue, such as to reduce costs or maintain a selected packing density. Alternatively, the user may take full control of the properties of the build, wherein the user may adjust any parameters as appropriate.

Once the sprue has been finalised, a digital record is generated 911 for the finalised design. The record may represent model data augmented by a unique ID for each of the parts making up the model data, and may subsequently be used to store an incremental digital history of that part that may be accrued during the manufacture of the part. This digital history may be made up of various types of information about the respective parts. For example, the digital history may identify the printer used to generate the parts. In some examples, the digital history may indicate where in the print bed the parts were printed. In some examples, the digital history may indicate where, when and how the parts were cooled after printing. This digital record may be updated, after identification, as the parts go through later workflow processes and acquire more historical data.

Modified model data is generated at 912, representing the parts and sprue. This modified model data may then be used by a 3D printer for printing the object.

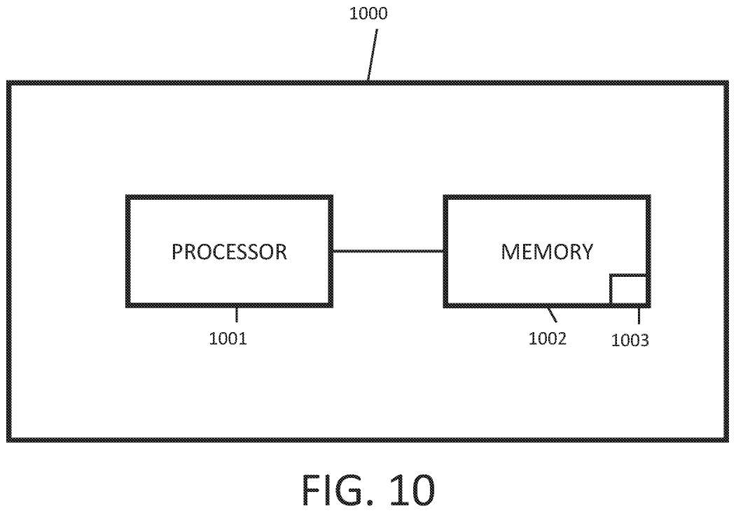

It should be understood that FIG. 10 illustrates an example method for the generation of modified model data which may then be used to generate print data. In some examples, the user may have the opportunity to input variables at various stages of the method. For instance, in some examples the user may input or adjust the properties of the connection type, or the arrangement of the parts, the sprue and the labels, after each respective stage of the process.

In some examples, the determination of the properties of the sprue, and arrangement of the parts, may take place in a different order from that shown in FIG. 10. For example, properties of the sprue may be determined before the arrangement of the parts. In some examples, machine learning may be implemented so that the system learns from previously determined sprues and applies the properties to future builds. In one application of this, the system may apply the properties to a number of identical builds so that the part may be mass produced without the need for individual approval by a user. In some examples, at each stage in the method of FIG. 10 the system may display the added cost per part printed on a sprue due to both the sprue cost and any overall loss in part packing density when compared to the print cost if no sprue were printed. This may enable the packer to decide whether to proceed with the packing scheme and associated sprue. The position and orientation of the final design generated from FIG. 10 may also be logged and attached to each digital record.

FIG. 10 shows an example of a controller 1000 configured to generate printer control data. The controller 1000 comprises a processor 1001 and a memory 1002. Stored within the memory 1002 are instructions 1003 for generating printer control data according to any of the examples described above. In one example, the controller 1000 may be part of a computer running the instructions 1003. In another example, the controller 1000 may be part of a 3D printer configured to run the instructions 1003 after obtaining model data.

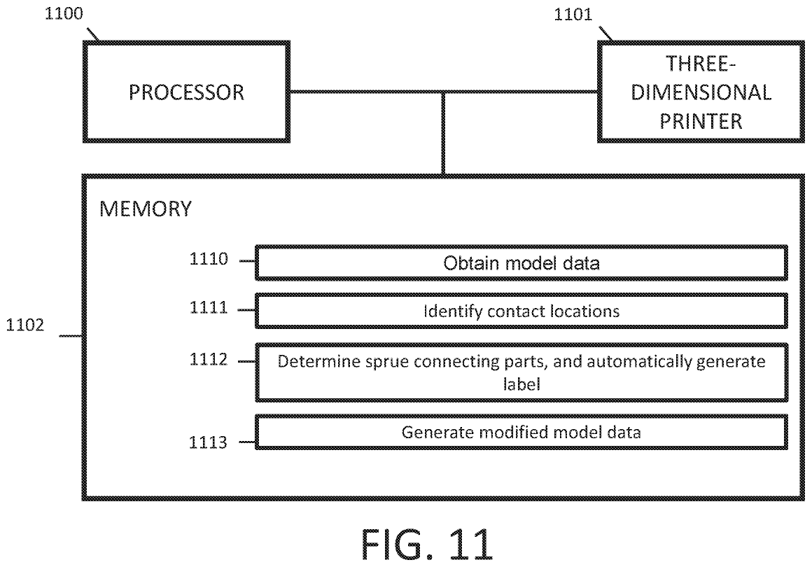

FIG. 11 shows a memory 1102, which is an example of a computer readable medium storing instructions 1110, 1111, 1112, 1113 that, when executed by a processor 1100 communicably coupled to an additive manufacturing system, in this case a 3D printer 1101, causes the processor 1100 to generate printer control data in accordance with any of the examples described above. The computer readable medium 1103 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

1. A method comprising:
obtaining model data defining at least two parts to be generated by a three dimensional printer;
identifying a contact location on each of the at least two parts;
determining a sprue to connect to the at least two parts at the contact location, wherein determining the sprue comprises automatically generating on the sprue a label identifying the parts connected to the sprue; and
generating modified model data representing an object comprising the at least two parts and the sprue, for generation by the three dimensional printer.

2. The method of claim 1, further comprising:
obtaining information regarding post-processing operations to be carried out on the generated parts; and
determining sprues to connect to the parts so as to group the parts according to post-processing operations common to the parts of each group.

3. The method of claim 2, wherein at least one sprue comprises two sections, each section respectively connected to at least one part, wherein the sections of the sprue are frangibly connected to one another to enable separation of the part(s) connected to each sprue section.

4. The method of claim 3, wherein at least one of the sprue sections is arranged to be further frangibly divisible to enable separation of parts connected to the at least one sprue section into sub-groups of at least one part.

5. The method of claim 2, further comprising repositioning at least one part within the model to reduce the distance between parts within a group.

6. The method of claim 1, wherein the sprue comprises a handle portion to facilitate handling of the object by an operator or handling system after printing.

7. The method of claim 6, wherein the label is located on the handle portion.

8. The method of claim 1, wherein determining the sprue comprises automatically determining parameters of the sprue on the basis of at least one parameter contained in the model data.

9. The method of claim 6, wherein determining the sprue comprises selecting a sprue construction from a set of predetermined sprue constructions, based on the model data.

10. The method of claim 1, further comprising selecting a connection type from a set of predetermined connection types, to provide a frangible connection between the sprue and at least one part at a respective one of the contact locations.

11. The method of claim 1, further comprising storing a record of manufacturing information for each part connected to the sprue, and associating the label with the record.

12. A system comprising a controller configured to:
obtain model data defining at least two parts to be generated by an additive manufacturing system;
identify a sprue connection location on each of the at least two parts;
generate sprue model data defining a sprue connecting the at least two parts by connecting to each part at the identified connection location, and automatically generate as part of the sprue model data a label identifying the parts connected to the sprue; and
generate modified model data representing an object comprising the at least two parts and the sprue, for generation by the additive manufacturing system.

13. The system of claim 12, wherein the controller is further configured to:
obtain information regarding post-processing operations to be carried out on the generated parts; and
determine sprues to connect to the parts so as to group the parts according to post-processing operations common to the parts of each group.

14. The system of claim 13, wherein at least one sprue comprises two sprue portions, each portion respectively connected to at least one part, wherein the respective sprue portions are frangibly connected to one another to enable separation of the part(s) connected to each sprue portion into sub-groups, at least one sub-group comprising a plurality of parts connected by the respective sprue portion.

15. A computer-readable medium comprising instructions that, when executed by a processor, causes the processor to:
obtain model data defining at least two parts to be generated by an additive manufacturing system;
identify a contact location on each of the at least two parts;
determine sprue data defining a sprue connected to the at least two parts at the respective contact location, and automatically generate as part of the sprue a label identifying the parts connected to the sprue; and
generate modified model data representing an object comprising the at least two parts and the sprue.
